(19) United States
(12) Patent Application Publication
(10) Pub. No.: US 2004/0130148 A1
(43) Pub. Date: Jul. 8, 2004

(54) Conventionally formed double O-ring coupling

(76) Inventors: Christopher Patterson, Olive Branch, MS (US); Stanley J. Sysak, Cordova, TN (US)

Correspondence Address: Joseph J. Pophal, PARKER-HANNIFIN CORPORATION, 6035 Parkland Boulevard, Cleveland, OH, 44124-4141, US

(21) Appl. No.: 10/726,139

(22) Filed: Dec. 1, 2003

Related U.S. Application Data
(60) Provisional application No. 60/438,853, filed on Jan. 8, 2003.

(51) Int. Cl. F16L 33/00

(52) U.S. Cl. 285/256; 285/259

(57) ABSTRACT

A connector for attachment to a tubular conduit, having a generally tubular metallic body. The tubular metallic body having a first portion, a second portion integral with the first portion having a smooth cylindrical outer surface adapted to be inserted into the conduit and a formed rounded rolled-over nose at its outer end, a longitudinally directed internal passage extending through the tubular body for receiving fluid flow, a first and second annular groove formed in the second portion axially spaced from each other, a first essentially constant diameter portion extending between the first annular groove and the second annular groove, and a second essentially constant diameter portion extending between the first annular groove and the first end portion.

### CROSS-REFERNCE TO RELATED CASES

The present invention claims the benefit of the filing date of U.S. Provisional Application Serial No. 60/438,853 filed Jan. 8, 2003, the disclosure of which is incorporated herein by reference.

### FIELD OF THE INVENTION

This invention is directed generally to tubular connectors and more particularly to tubular connectors for use in automotive applications.

### BACKGROUND OF THE INVENTION

Tubular connectors are attached to fluid conveying conduits and form an assembly that can be used in fluid systems. Tubular connectors are generally comprised of a tube and a shell usually made of a metallic material. The shell, which is fitted over the conduit, is affixed to the tube, which is inserted into the conduit. The shell is then inwardly or radially compressed so that the conduit is retained and sealed there-between. A proper seal and full physical retention are necessary so that leakage and separation are avoided.

Most currently available tubular connectors utilize tube designs with retaining barbs on the tube outer surface so that a seal is established between the barbs and the inner surface of the conduit. Examples of these types of tube designs are shown in prior art constructions such as U.S. Pat. No. 5,387,016 to Joseph et al., U.S. Pat. No. 5,961,157 to Baron et al., and French Pat. 2,675,880-A1 to Pineda. These barbs also provide a retention means between the tube and the conduit inner surface when the shell component is inwardly compressed. A disadvantage with this type of design is that the barbs can damage the inner surface of the conduit, thus providing a leak path for the fluid. Due to the snug fit between the tube and the conduit, the conduit inner surface can also be damaged when the tube is inserted inside the conduit.

Other currently available tubular connectors utilize O-rings, or other forms of elastomeric seals, retained on their outer surfaces in order to provide a seal between the tube and the conduit. Examples of these types of designs are shown in prior art constructions such as U.S. Pat. No. 5,044,671 to Chisnell et al., U.S. Pat. No. 5,378,023 to Olbrich, U.S. Pat. No. 5,984,376 to Lampe, and the aforementioned French Pat. 2,675,880-A1 to Pineda. In each of these designs, the O-rings are used to provide a seal between the two metal components. Other design attributes, such as barbs or ridges provide the retaining means in this type of design. As mentioned above, the barbs can possibly damage the inner surface of the conduit, providing a leak path. Another disadvantage of these designs is that during assembly of the conduit with the connector, the O-ring can move with the conduit, thus leaving its designed receiving area and seriously impairing its sealing function.

Roll forming techniques for the construction of tubular connectors is advantageous since the formed areas are not left with chips, flakes or sharp edges. Other currently available tubular connectors have roll formed tubular connectors, but only with select metal material. 5000 series aluminum alloys are desired metallic materials since they are lighter and stronger than most currently used aluminum alloy materials. Roll forming these materials though is difficult due to their poor forming properties. It is common to shear portions of the part being formed during the fabrication thereof.

### SUMMARY OF THE INVENTION

The present invention provides a tubular connector having a tube, or nipple, with a smooth surface. Two annular grooves are formed within the surface of the tube and extend around its circumference. A portion of the tube, located near its distal end, downwardly slopes from one of the grooves to the nose of the tube. The nose of the tube is rounded such that it allows for easy insertion of a conduit into the connector. The rounded nose, sloped portion, and shape of the grooves provide for proper fabrication of a hose assembly thus avoiding the displacement of o-rings or the damaging of the inner surface of the conduit.

More specifically, the present invention has provided the connector for attachment to the tubular conduit, the connector having a generally tubular metallic body comprised of a first end portion and a second end portion. The second end portion adjoins the first end portion, has a smooth cylindrical outer surface adapted to be inserted into the conduit, and includes a formed rounded rolled-over nose at its outer end. A longitudinally directed internal passage extends through the tubular body for receiving fluid flow. The second end portion has a first annular groove formed within and a second annular groove, axially spaced from the first annular groove, also formed within. The second end portion also includes a decreasing outside diameter portion extending slopingly from the second annular groove to its outer end. A first essentially constant diameter portion extends between the first annular groove and the second annular groove. A second essentially constant diameter portion extends between the first annular groove and the first end portion. An added feature of the noted connector includes having the first and second annular grooves being roll formed via a radial impingement process.

Another attribute of the noted connector includes having the generally tubular body being fabricated from a 5000 series aluminum alloy. A further feature of the noted connector has each of the first and second annular grooves being adapted to receive an annular sealing/retention member having a greater outside diameter than that of the tubular body second end, and wherein the sealing/retention member is adapted to sealingly engage the inner peripheral surface of the tubular conduit and completely fill the annular grooves while in compression.

Another feature of the noted connector includes the generally tubular body having an annular peripheral retaining groove located at the junction of the first and second end portions, being formed in the junction, and adapted for receiving an annular end portion of a generally cylindrical shell which surrounds and is radially spaced from the outer surface of the tubular body second end. The shell has an open end for receiving an end of the conduit and its annular end portion affixedly terminates within the retaining groove. The shell is also adapted to be inwardly deformed, once the conduit end is received therein, such that a plurality of axially spaced radially inwardly-depending detents are formed therein for elastically deforming the conduit end. Still another feature includes having the detents being arranged so that a first detent is radially positioned over the decreasing outside diameter portion, a second detent is radially positioned between the first and second grooves and a third detent is radially positioned between the first annular groove and the retaining groove. Another feature includes having the detents extending along the circumference of the shell.

Still yet another feature has the first and second annular grooves being rounded and adapted to receive a ring-shaped sealing/retention member which has a greater outer diameter than that of the tubular second end portion while located within the grooves and engages the inner peripheral surface of the tubular conduit when the conduit is subject to radial compression. A further attribute of the noted connector has the sealing/retention member taking the form of an O-ring, which has a relaxed inner diameter less than the minimum diameter of the bottom surface of the annular grooves.

A further feature has the noted connector where the annular grooves are curvilinear and include side portions having a first curvilinear shape and a bottom portion having a curvilinear shape differing from that of the side portions, with the intersections of the side and bottom portions defining a similar longitudinally-spaced circular transition lines that functions to aid in the retention of a sealing/retention member located within the grooves. Further features and advantages of the present invention will become apparent to those skilled in the art upon review of the following specification in conjunction with the accompanying drawings.

### BRIEF DESCRIPTION OF THE DRAWINGS

FIG. 1 is a longitudinal cross-sectional view of a hose assembly embodying the present invention.

FIG. 2 is a longitudinal cross-sectional view of a tubular element of the present invention.

FIG. 3 is a longitudinal cross-sectional view of the tubular element, similar to FIG. 2, with the addition of O-rings in place.

FIG. 4 is a longitudinal cross-sectional view of a tubular connector, comprised of the tubular element, as shown in FIG. 2, with the addition of an affixed shell.

FIG. 5a is a longitudinal cross-sectional view of a first roller tool used in the present invention forming process.

FIG. 5b is a longitudinal cross-sectional view of a second roller tool used in the present invention forming process.

FIG. 5c is a longitudinal cross-sectional view of a third roller tool used in the present invention forming process.

FIG. 6 is an enlarged partial view of the second roller tool surface area designated by circle 6-6 in FIG. 5a.

FIG. 7 is an isometric view showing the three roller tools, together with the tubular element, used in the present invention forming methods.

### DETAILED DESCRIPTION OF THE PREFERRED EMBODIMENT

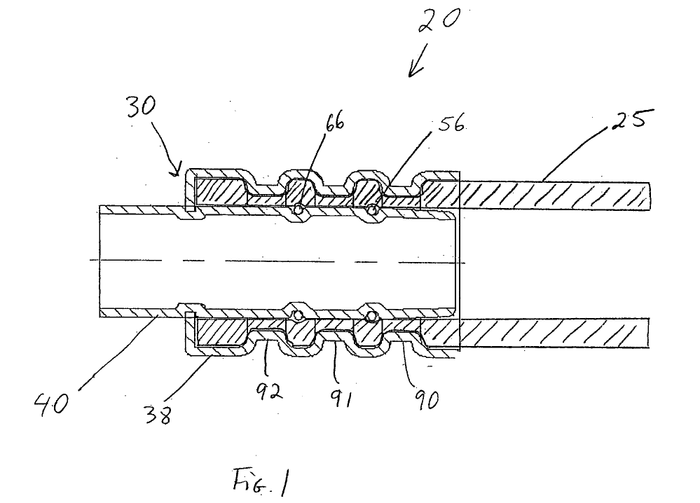

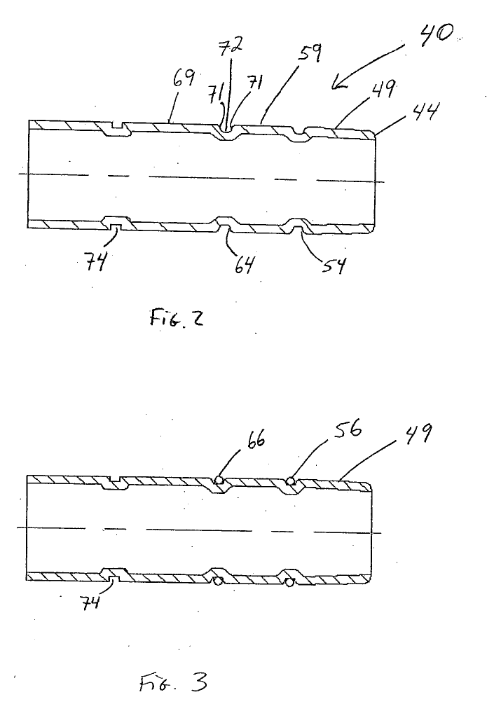

Referring to the drawings, and initially to FIG. 1, a hose assembly 20, including a tubular connector 30 and a conduit 25, is shown. Tubular connector 30, comprised of a shell 38 and a tube 40, is designed for fixed attachment to a conduit 25 used for fluid transfer in various applications, for example automotive. As is discussed in detail below, the present invention provides a simplified manufacturing process for developing contours in a smooth-finish tube so as to produce contoured tube 40, as best seen in FIG. 2, having ideal retention and sealing attributes with reference to conduit 25. In addition, this new design and its manufacturing process ensure that the inner peripheral surface of conduit 25 is not damaged during fabrication of hose assembly 20.

Tube 40 has several unique features that assist in the sealing engagement of conduit 25 with connector 30. A leading outer annular edge, or nipple nose 44, of tube 40, is rolled-over or relieved in order to aid with the installation of conduit 25 onto tube 40. The outer diameter of tube 40 is dimensionally close to the inner diameter of conduit 25 so that a proper seal can be achieved. Therefore, when conduit 25 is fitted onto tube 40, nipple nose 44 can impair the integrity of the inner peripheral surface of conduit 25 if nipple nose 44 is not rounded. For example, if nipple nose 44 has a sharp outer edge, the inner peripheral surface of conduit 25 can be nicked or scratched, thus providing a possible leakage path for the fluid being transferred through hose assembly 20.

Tube 40 has a smooth, slightly tapered outer surface portion 49 or a uniformly decreasing outside diameter portion 49, extending from nipple nose 44 to a first rounded peripheral groove 54, formed within tube 40. For example, tapered surface 49 can have a 2° pitch or taper. As mentioned above, the dimensional interface between the inner peripheral surface of conduit 25 and the outer peripheral surface of tube 40 is close or snug so that a full circumferential seal can be formed. The sloped or tapered surface 49 assists in the connection of hose assembly 20 with tube 40 when conduit 25 is united with tube 40, as well as ensures that the inner peripheral surface of conduit 25 remains undamaged. First rounded groove 54 extends peripherally around the circumference of tube 40 and serves to receive an O-ring 56, as best seen in FIG. 3, having a greater outer diameter than that of tapered surface 49. During the connection of conduit 25 with tube 40, when conduit 25 and tube 40 slide relative to each other, it is imperative that O-ring 56 stays within first groove 54 and does not move with conduit 25. Tapered surface 49 ensures that O-ring 56 not only remains located within first groove 54, but also functions as a peripheral seal between tube 40 and conduit 25.

A smooth, flat outer surface portion 59 of tube 40 extends between first groove 54 and a second rounded groove 64 formed within tube 40. Similar to first groove 54, second groove 64 extends peripherally around the circumference of tube 40 and also serves to receive an O-ring 66 that provides a further peripheral seal between conduit 25 and tube 40. O-rings 56, 66 have an inner diameter less than, for example in the range of 10-30%, the inner diameter of grooves 54, 64 such that O-rings 56, 66 are stretched in order to fit within grooves 54, 64, thus providing better retentions thereof.

Both surface portions 49 and 59 have a smooth surface or profile, contrary to other tubular designs that have a barbed outer profile. Typically, tubes use a barbed profile in order to provide retention between the conduit and tube. The barbs grip the inner peripheral surface of the conduit, which, for example, is made of an elastomeric or thermoplastic material, thus giving the conduit a greater resistance to being pulled out of the connector. The barbs also serve to provide a sealant surface between the conduit and the tube. Typically, if a barbed tube is used in conjunction with a thermoplastic or elastomeric conduit, a chemical sealant, such as Chemlock™, is applied to the barbs in order to produce a chemical seal between the tube and the conduit. Tubes having a barbed outer profile and using a sealant do not require O-rings on their peripheral surfaces since the sealant already provides the seal. Due to safety issues and new environmental standards, the use of a chemical sealant is not preferred. The use of O-rings 56, 66 not only adds sealing and retention properties to hose assembly 20, but also provides a safer, and more environmentally friendly, fabrication or assembly process for the end user. In addition, while barbs provide sealing and retaining means, they can also damage the hose inner peripheral surface and provide a possible leak path for the fluid being transferred. Although the smooth profiles of surface portions 49 and 59 do not provide retention means, they will not damage the inner peripheral surface of conduit 25. The noted smooth profiles also simplify the manufacturing process of tube 40 since barbs need not be machined into its outer surface.

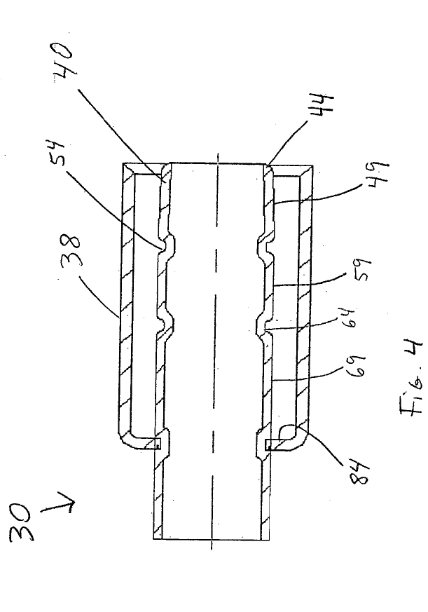

Located on the side opposite of flat surface portion 59, of tube 40, and extending from second groove 64, is another smooth, flat surface portion 69. Surface portion 69 extends from second groove 64 to a generally rectangular peripheral retaining groove, or notch 74. Surface portion 69 extends well past second O-ring groove 64 (towards groove 74) such that the proximate end of conduit 25, when fully inserted into connector 30 (as shown in FIG. 1) also extends well past second O-ring groove 64. This insures that a full peripheral proper seal between O-ring 66, groove 64 and conduit 25 will exist even if the proximate end of conduit 25 is not properly cut prior to its insertion into tubular connector 20. Specifically, it is common for the proximate end of conduit 25 to be improperly cut at an angle, rather than squarely. If conduit 25 is cut at an angle, the shorter, relieved portion will still not be in close axial proximity to second groove 64. In other words, due to the axial or longitudinal distance between notch 74 and groove 64, an improperly angle cut conduit 25 will still be completely sealed by O-ring 66. Generally rectangular retaining groove or notch 74 extends peripherally around the circumference of tube 40 and, as shown in FIG. 4, serves to affixedly receive a coupling shell, or socket, 38. Shell 38 has an inner, annular, vertically oriented surface portion 84 which acts as an abutting face for conduit 25 when fully inserted into connector 30.

Referring to FIGS. 2 and 3, grooves 54, 64, which are substantially similar have a total radial depth such that the outer peripheral surface of O-rings 56, 66 extend above surfaces 49, 59, and 69, by approximately 0.010-0.020″. The formed radii at the sides and bottom of grooves 54, 64 combine to comprise the total depth. For example, groove 64 has a side radii 71 of 0.025″ and a bottom radius 72 of 0.015″ for a total depth of 0.040″. By utilizing these differing contours, radii 71 and 72 have opposed annular transition lines therebetween that function to retain O-ring 66, when tube 40 is united with tubular connector 30 and passes over O-ring 66. Groove 54 and O-ring 56 have a substantially similar contour and retention means. The lateral width of grooves 54, 64 is such that when O-rings 56, 66 are compressed, as seen in FIG. 1, they completely fill grooves 54, 64 and continue to have curvelinear annular portions therein extending above surfaces 49, 59, and 69.

To properly fabricate hose assembly 20, the following steps are taken. Referring to FIGS. 1 & 4, conduit 25 is inserted into tubular connector 30 such that tube 40 is positioned inside of conduit 25 and shell 38 covers the outer surface of conduit 25. As previously detailed, conduit 25 is initially placed over nipple nose 44 which provides a smooth lead for the inner peripheral surface of conduit 25. Conduit 25 then travels over tapered surface 49 so that its inner diameter expands while progressing over O-ring 56. Due to the contour of groove 54 and tapered surface 49, O-ring 56 remains within groove 54 during the movement of conduit 25. Conduit 25 moves along flat surface 59 and is still expanded due to the angle of tapered surface 49. Conduit 25 then passes over, without dislodging, O-ring 66, and moves along surface 69 until it abuts inner annular surface 84 of shell 38.

Once conduit 25 has been fully inserted into connector 30, shell 38 is intermittently directed radially inwardly, via permanent deformation, so that successive axial portions of conduit 25 are radially compressed between shell 38 and tube 40. Shell 38 can be deformed inwardly by varying methods, well known in the art, such as a crimping operation or by the tightening of circumferential bands (not shown) around the outer surface of shell 38. Regardless of which method is utilized, the inwardly directed forces on shell 38 preferably should not be applied directly over O-rings 56 and 66. In order to provide the best possible sealing and retention between conduit 25 and connector 30, the inwardly directed forces are applied in three areas: axially between nipple nose 44 and first groove 54 (as indicated by a first detent 90), axially between first groove 54 and second groove 64 (as indicated by a second detent 91), and axially between second groove 64 and retaining groove 74 (as indicated by a third detent 92). When fabricated in the above fashion, O-rings 56 and 66 are compressed and completely fill grooves 54 and 64. The rounded outer extents of O-rings 56 and 66 remain at a greater outer diameter than that of tube 40 and provide both the retaining means, relative to conduit 25, as well as acting in peripheral sealing capacity relative to conduit 25. Since tube 40 is provided with a smooth outer surface or profile and thus does not have a barbed profile, O-rings 56 and 66 replace both the sealing and retention functions of the barbs.

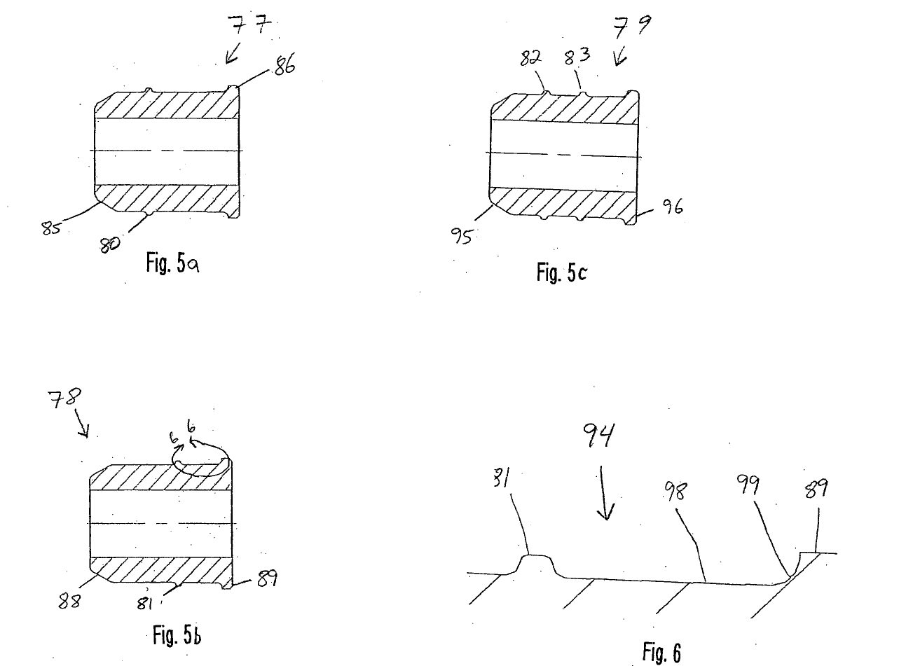

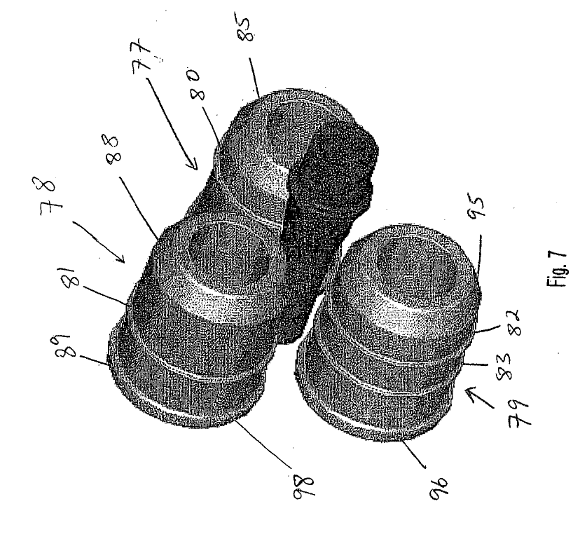

The process of forming tube 40 will now be discussed in more detail. Referring to FIGS. 5a, 5b, and 5c, the tools used for the forming process are shown in the form of cylindrical rollers, 77, 78 and 79. First roller 77, shown in FIG. 5a, has a protrusion 80 extending from its outer periphery that is shaped similar to second groove 64 of tube 40. Protrusion 80 is positioned closer to the front or nose portion 85 of roller 77 than to its base 86. Second roller 78, shown in FIG. 5b, has a protrusion 81 extending from its outer periphery that is shaped similar to first groove 54 of tube 40. Protrusion 81 is positioned closer to the base 89 of roller 78 than to its nose 88. Third roller 79, shown in FIG. 5c, has two first and second protrusions 82 and 83 respectively, both extending from its outer periphery. First protrusion 82 is shaped similar to second groove 64 while second protrusion 83 is shaped similar to first groove 54. When all of the rollers are situated for the forming process, as shown in FIG. 7, third roller first protrusion 82 is radially aligned with first roller protrusion 80, and third roller second protrusion 83 is radially aligned with second roller protrusion 81.

Referring to FIG. 6, an enlarged outer circumferential surface segment 94, close to base 89 of second roller 78, is shown and includes a tapered portion 98 and a radiused portion 99 extending between protrusion 81 and base 89. Surface segment 94 is also indicative of the surface of rollers 77 and 79. Tapered portion 98 extends from protrusion 81 into a radiused portion 99. Tapered portion 98 is angled similarly to tapered surface 49 of tube 40, for example at a 2° pitch. Likewise, radiused portion 99 has a profile similar to that of tube nipple nose 44. Roller nose portions 85, 88 and 95 each are tapered at an approximate angle range of 25°-45°. This angle provides a relief for and prevents tube material from flowing into tube retaining groove 74 during the tube forming process.

In order to form tube 40, rollers 77, 78 & 79 are positioned on approximately triangularly-spaced, parallel axis roller holders (not shown) with cylindrical bearing liners and pins holding them in place. The roller holders in-turn hold the rollers in a roll-forming machine (not shown). Each roller is journaled by two-spaced needle bearings (not shown) located on its inner peripheral surface in order to allow each roller to spin or rotate independently of the others. Rollers 77-79 (and their respective roller holders) are affixed to a cylindrical shaft on the roll-forming machine and positioned in a fixed angular position (as shown in FIG. 7), approximately 120° apart from one another. The cylindrical shaft rotates, for example, at a speed of 300-800 rpm for forming a 5000 series aluminum alloy tube. A constant diameter 5000 series aluminum tube is placed into a slot opening in the front of the machine while grip blocks, or jaws (not shown), close to hold the tube firmly in place. Rollers 77-79 extend radially inwardly and contact the tube simultaneously. Rollers 77 and 78, which have but one protrusion each, contact the tube and roughly form or preform grooves 64 and 54 respectively. Since these rollers have only one protrusion, the forces produced by the radial contact are concentrated on the one protrusion, allowing more material to be displaced with less contact necessary. Roller 79, having the two protrusions 82 and 83, final-form the grooves 54, 64 and particularly the radii at the sides and bottom of both grooves 54 and 64.

When contact is made with the constant diameter tube, rollers 77-79 spin freely and displace, or move, the metallic material, thus forming grooves 54 and 64. Without the ability to spin freely, rollers 77-79 would act like a cutting tool, thereby removing material. When moving the material, metal flows from underneath protrusions 80-83 in both axial directions. In a similar manner, tapered surface 98 of each roller 77-79 also displaces material toward radiused portion 99. The displacement of material by tapered surface 98 on rollers 77-79 forms tapered surface 49 on tube 40. Radiused portion 99, on each roller 77-79, contacts the annular outer end on the tube and provides the rolled-over shape to produce finished nipple nose 44. The material displaced from grooves 54, 64 and by tapered surface 98 also helps to finish the radius on nipple nose 44 so that it is rounded and does not damage the inside of conduit 25 during fabrication of assembly 20. After the proper formation of grooves 54, 64, taper 49 and nipple nose 44, rollers 77-79 return to their original position and grip blocks release tube 40.

Typical uses for 5000 series aluminum alloys are primarily for sheet metal applications such as road signs and exterior bodies of small marine craft. Due to its excellent corrosion resistance and overall toughness, its use in mobile fluid transfer applications is desired. Unfortunately the 5000 series alloys suffer from poor machinability, so roll-forming techniques must be used. In order to roll-form 5000 series aluminum alloy materials, the contact pressure of rollers 77-79 for forming tube 40 needs to be reduced from that of conventional roll-forming processes known in the art. Likewise, the rotational speed of the cylindrical shaft holding rollers 77-79 also has to be reduced. Known roll-forming processes have rotational speeds of up to 1400 rpm, when forming metals such as 3000 series aluminum alloy material. This latter speed will separate the portions of tube nipple from tube 40 if performed on a 5000 series aluminum alloy material. In order to reduce the contact and pressure, rollers 77, 78 are designed with only one protrusion 80 and 81, respectively. By reducing the surface contact between rollers 77, 78 and tube 40, a smooth finish is produced in grooves 54 and 64, without leaving chips or flakes. Since grooves 54 and 64 are a primary sealing surfaces, they need to be clean and smooth. Similar to excessive rotational speed, too much contact (or torque) between rollers 77-79 and tube 40 will cause a portion of tube 40 to be separated. With but one protrusion on rollers 77 and 78, the torque applied to tube 40 is reduced by about one third. Minimal contact coupled with the slower rotational speed, as discussed above, provides a workable process combination that keeps tube 40 intact during its roll-forming process.

It should be noted that the present invention is not limited to the specified preferred embodiments and principles. Those skilled in the art to which this invention pertains may formulate modifications and alterations to the present invention. These changes, which rely upon the teachings by which this disclosure has advanced, are properly considered within the scope of this invention as defined by the appended claims.

What is claimed is:

1. A connector for attachment to a tubular conduit, having a generally tubular metallic body comprised of:
a first end portion;
a second end portion, adjoining said first end portion, having a smooth cylindrical outer surface adapted to be inserted into said conduit, said second end portion including a formed rounded rolled-over nose at the outer end thereof;
a longitudinally directed internal passage extending through said tubular body for receiving fluid flow;
a first annular groove formed in said second end portion;
a second annular groove, axially spaced from said first annular groove, also formed in said second end portion;
said second end portion including a decreasing outside diameter portion extending slopingly from said second annular groove to the outer end thereof;
a first essentially constant diameter portion extending between said first annular groove and said second annular groove; and
a second essentially constant diameter portion extending between said first annular groove and said first end portion.

2. The connector as in claim 1 wherein said first and second annular grooves are roll formed via a radial impingement process.

3. The connector as in claim 1 wherein each of said first and second annular grooves is adapted to receive an annular sealing/retention member which has a greater outside diameter than that of said tubular body second end, said sealing/retention member, being adapted to sealingly engage the inner peripheral surface of said tubular conduit, and completely fill said annular grooves while in compression.

4. The connector as in claim 1 wherein said generally tubular body includes an annular peripheral retaining groove located at the junction of said first and second end portions, said retaining groove being formed in said junction and adapted for receiving an annular end portion of a generally cylindrical shell surrounding and radially spaced from the outer surface of said second end of said tubular body, said shell also having an open end for receiving an end of said conduit, with said shell annular end portion affixedly terminating within said retaining groove, said shell being adapted to be inwardly deformed, once said conduit end is received therein, such that a plurality of axially spaced radially inwardly-depending detents are formed therein for elastically deforming said conduit end.

5. The connector as in claim 4 wherein said plurality of axially spaced detents are comprised of a first detent radially positioned over said decreasing outside diameter portion, a second detent radially positioned between said first and said second groove and a third detent radially positioned between said first annular groove and said retaining groove.

6. The connector as in claim 4 wherein said detents extend along the circumference of said shell.

7. The connector as in claim 1 wherein said generally tubular body is fabricated from a 5000 series aluminum alloy.

8. A connector for attachment to an elastic tubular conduit, having a generally tubular metallic body comprised of:
a first portion,
a second portion integral with said first portion and having a smooth cylindrical outer surface adapted to be inserted into said conduit,
a longitudinally directed passage extending longitudinally through said first and said second portions for receiving fluid flow therethrough,
at least one annular, outwardly-directed groove formed in said second portion; and
an essentially constant diameter portion in said second portion adjoining at least one side of said at least one annular groove.

9. The connector as in claim 8 wherein said second portion includes an outer end portion having a formed, rounded nose.

10. The connector as in claim 9 wherein said second portion includes a uniformly decreasing outside diameter portion extending from the most proximate one of said at least one annular groove to said outer end-portion.

11. The connector as in claim 8 wherein said at least one annular groove is produced via roll-forming process.

12. The connector as in claim 8 wherein said at least one annular groove is a rounded groove and adapted to receive a ring-dashed shaped sealing/retention member which has a greater outer diameter than that of said tubular body second portion while located within said at least one annular groove and engages the inner peripheral surface of said tubular conduit when said conduit is subject to radial compression.

13. The connector as in claim 12 wherein said sealing/retention member takes the form of an O-ring having a relaxed or uninstalled inner diameter less than the minimum diameter of the bottom surface of said at least one rounded annular groove.

14. The connector as in claim 8 wherein said generally tubular body has an annular peripheral retaining groove formed between said first and second portions and is adapted for receiving a generally cylindrical shell surrounding and radially spaced from the outer surface of said second end of said tubular body, said shell having an open end for receiving said elastic tubular conduit and a closed annular end affixedly terminating within said retaining groove.

15. The connector as in claim 8 wherein said generally tubular metallic body is fabricated from a 5000 series aluminum alloy.

16. The connector as in claim 8 wherein said at least one annular outwardly-directed groove is curvelinear and includes side portions having a first curvelinear shape and a bottom portion having a curvelinear shape differing from that of said side portions, with the intersections of said side and bottom portions defining substantially similar longitudinally-spaced circular transition lines that function to aid in the retention of a sealing/retention member located within said at least one annular groove.
